(19) United States
(12) Patent Application Publication
(10) Pub. No.: US 2023/0405495 A1
(43) Pub. Date: Dec. 21, 2023

(54) Filter Containing Flow Disrupter

(71) Applicant: Fernox Limited, Woking, Surrey (GB)

(72) Inventors: Mark Hall, Woking, Surrey (GB); Samuel Hayes, Woking, Surrey (GB)

(21) Appl. No.: 18/035,010

(22) PCT Filed: Nov. 10, 2021
(86) PCT No.: PCT/EP2021/025438

§ 371 Date: May 2, 2023

(30) Foreign Application Priority Data
Nov. 11, 2020 (GB) 2017802.6

(51) Int. Cl. B01D 21/00; B01D 21/24; F24D 19/00

(52) U.S. Cl. CPC B01D 21/0042; B01D 21/0087; B01D 21/0024; B01D 21/2483; B01D 21/0003; F24D 19/0092

(57) ABSTRACT

A filter for removing particles held in suspension by a fluid. The filter includes (a) a manifold having an inlet and an outlet; and (b) a main filter body connected to the manifold. The main filter body includes a flow disrupter, the flow disrupter comprising a tiered plate assembly arranged in the filter body and each plate in the tiered plate assembly comprises an arrangement of apertures. The inlet of the manifold, the tiered plate assembly, the outlet of the manifold and a bottom of the main filter body define a flow path for fluid to be treated.

### FIELD OF THE INVENTION

The present invention relates generally to a fluid cleaning device for flowable fluids, such as water circulating through a central heating system.

### BACKGROUND OF THE INVENTION

In hydronic heating and/or cooling systems, which typically comprise pipes, along with associated components such as pumps, heat exchangers, generators, control systems, etc., it is common to take steps to treat the heat-transfer fluid (i.e., water, optionally with the addition of glycol or similar substances) to remove impurities.

In fluid flow systems including ferro-metallic components—such as steel valves and fittings—even if used with copper or plastics piping—there is inevitably debris detached from metallic components, including the interior surfaces of steel or iron central heating radiators, or other heat exchange surfaces, in the form of iron oxide particles and other sludge forming debris. Old systems, in particular, can have a very high concentration of ferrous particles that can be released from system components, particularly from iron pipes and radiators. As components begin to break down, a type of iron oxide (often referred to as sludge or magnetite) is formed.

These impurities may be circulated by one or more pumps included in the system and can accumulate at critical points of the system, including, for example control elements and other critical components, including boilers, refrigerators, heat pumps, etc.). Such impurities can affect the efficient operation of said components and, if not properly removed, can reduce the efficiency of the system over time, leading to damaged components.

In addition, such impurities can also lead to perforated pipes caused by corrosion. When the accumulated impurities come into contact with the oxygen that is present in water, the accumulated impurities can oxidize the parts of the system where they deposit, causing corrosion of parts and resulting in a perforated pipe.

Thus, it is desirable to take steps to maintain the heat-transfer fluid so that it is as clean as possible and free from impurities.

For example, filters can be used at various points in the system to remove any circulated debris present within the system so that it does not reach valuable components such as pumps or heat exchangers.

Domestic heat system filters typically employ the use of a magnet, alone or in combination with a secondary means of filtration, which works in combination to capture system debris. Thus, these filters trap the impurities using gravity, strainers and/or magnets so that the impurities do not build-up in the system or block up the boiler. However, it would be desirable to boost the overall performance of the filter, especially to improve the capture of non-magnetic debris.

Due to the iron content of the sludge, the dirt is magnetic and can be filtered from the system using magnetic filtration. Magnetic filtration works by capturing the impurities and/or dirt and/or debris by a magnet as system water passes through a magnetic filter. Thus, magnetic particles pass over the magnet and are captured by the magnet and removed by the system. The effectiveness of a magnetic filter relies on the strength of the magnet used in combination with the design and functionality of the internal components. The most effective filtration can be achieved by temporarily reducing the flow of water through the filter and directing particles onto the magnet. In one instance, a high power neodymium magnet is used.

The devices described below can be used in combination with a magnet to improve removal of impurities from the system.

In hydrocyclonic filtration, a hydrocyclone applies centrifugal force to a liquid to promote separation of particles from the liquid. The hydrocyclone is a static device that is designed to convert incoming liquid velocity into rotary motion. As water enters the filter, its spins around and down to outside of the filter, carrying particles with it. The shape of the filter is designed to create a dead zone at the bottom where heavier particles are deposited. Once the flow of water reaches the bottom of the filter, water moves back up through the center of the filter, carrying particles past a magnetic sheath, which promotes further magnetic filtration and enhances the collection capabilities of the filter.

Also used may be a hydronic particle separator, which works by disrupting the flow of water through the filter, and in doing so removes particles held in suspension by the water. The hydronic particle separator encourages a change in flow trajectories of these particles, allowing particles to settle into the body and base of the filter. During this process, the effectiveness of the magnetic is increased as the hydronic particle separator decreases the velocity of both magnetic and non-magnetic particles. As the speed at which magnetic particles pass over the magnet is decreased, the efficiency of the magnet is increased.

Another type of particle removal device uses a mesh to filter dirt by acting to remove dirt particles from a suspension in the water. As water passes through the mesh, particles held in suspension are disrupted and, as such, begin to settle in the body of the filter. Unlike a hydronic particle separator, most mesh designs do not encourage a flow trajectory of the water, and as such rely on particles coming into direct contact with the mesh in order to begin to settle. Thus, the first pass efficiency of a mesh is often very low, and in general, the amount of time taken to filter particles from a system using just a mesh is much longer than in comparably sized magnetic filters.

Plastic mesh may also be used for particle separation. However, as most of the plastic meshes are made up of thicker cross sections than their metal counterparts, they are often used in a slightly different way. In some examples, the device is rolled in on itself to crease a dense plastic mesh, which is then packed inside the body of the filter. In this way, the mesh is likely to dramatically reduce the flow of water through the filter, and in doing so, allow particles carried by the water to settle in the filter. Although in some cases this collection technique can prove to be relatively effective, the process of cleaning the filter can be a lengthy and problematic process. Much of the dirt can remain built up inside the mesh, requiring that the mesh be regularly removed, cleaned and repositioned in the filter.

Also used, is a combination of a mesh that sits around an internal magnet. The principle behind this arrangement is to help reduce the flow of water as it passes over and around the magnet, helping to enhance the effectiveness of the magnetic collection. Although this technique does not increase the total amount of dirt the magnet is capable of capturing, it does significantly improve the speed at which the magnet can remove contaminants from the system. Depending on the size and strength of the magnet, the ratio between the magnet and mesh can be wrong, meaning that dirt can often collect around and through the mesh, making servicing a challenge.

Another type of mesh is a so-called “donut” mesh that sits at the bottom of the filter and works to reduce the flow of water in this area. As a result, this reduction in flow can encourage dirt particles to settle with greater ease. The density of the mesh means that dirt does not become trapped in the mesh, rather it builds up around the mesh, making cleaning a relatively straightforward process. The shape of the mesh reflects the shape of the filter body, maximizing the surface area covered by the mesh, and as such increasing the overall collection capability of the device. The donut is held in place by the magnetic sheath which fits through the center of the mesh.

Still another type of particle separation device comprises a sheath capture device that is built around an internal magnetic sheath. For example, a round section at the bottom of the sheath serves to collet dirt particles as water moves through the body of the filter. As water passes over and into the bottom section of the sheath, it carries dirt into the devices. One of the drawbacks of this device is that the effectiveness of the device as well as the impact it has on the overall collection total can be limited. In addition, the lengthy process involved in cleaning the device during service can outweigh the amount of dirt captured inside.

In still another type of particle separation device, rather than using the shape of the filter body to create a cyclonic action within the filter, individual cyclones can be built into a section of the filter. For example, a molded insert can be positioned in the filter, with water moving through the filter. By doing so, impurities are encouraged to concentrate, collect, and settle into the bottom of the filter body. However, the size of the cyclone molding in some instances is not optimized to capture the maximum amount impurities. This has a significant impact on the efficacy of the design, meaning that impurities are often more likely to become trapped in these cyclones, rather than to improve the overall collection of debris. Several techniques and method are known in the art for removing impurities from the fluid flowing in pipes of a water supply system, in particular a heating and/or cooling system.

In contrast to mechanical methods, chemical additives may also be used to neutralize impurities contained in the fluid. However, this method has some important drawbacks including that the presence/absence of such additives must be constantly monitored and the system has to be shut down in order to add more additive when its concentration is insufficient and/or lower than required for effectively removing the impurities.

However, it would be desirable to boost the overall performance of the filter to capture both magnetic and non-magnetic impurities and debris from the system. There remains a need in the art for an improved filter for removing dirt and debris from fluid in a central heating system that overcomes the deficiencies of the prior art and that is capable of improved performance in removing impurities and debris.

### SUMMARY OF THE INVENTION

It is an object of the present invention to provide a filter for treating a fluid in a water supply system, which overcomes the drawbacks of the prior art.

It is another object of the present invention to provide a filter that is capable of capturing both magnetic and non-magnetic debris.

It is still another object of the present invention to provide a filter that does not require the use of a magnet for the removal of magnetic debris.

It is still another object of the present invention to provide a filter that can be used in a domestic system.

It is still another object of the present invention to provide a filter that can be used in a heat pump system.

It is still another object of the present invention to provide a filter that is both low cost and high performance.

To that end, in one embodiment, the present invention relates generally to a filter for removing particles held in suspension by a fluid, the filter comprising:
a. a manifold having an inlet and an outlet;
b. a main filter body connected to the manifold, wherein the main filter body comprises a flow disrupter, the flow disrupter comprising a tiered plate assembly arranged in the filter body, wherein each plate in the tiered plate assembly comprises an arrangement of apertures,
   wherein the inlet of the manifold, the tiered plate assembly, the outlet of the manifold and a bottom of the main filter body are configured to define a flow path for fluid to be treated, the flow path entering through the inlet of the manifold, passing into the filter body and down through the apertures of the tiered plate assembly, and passing the bottom of the main filter body which is configured to collect particles removed from suspension in the fluid to settle into the bottom of the main filter body, and the flow path being redirected back up through the tiered plate assembly to exit through the outlet of the manifold.

In use, fluid to be treated enters the filter through the inlet of the manifold, passes into the filter body and down through the apertures of tiered plate assembly and is redirected back up through the tiered plate assembly to exit through the outlet of the manifold, whereby particles held in suspension by the fluid are removed and settle into a bottom of the main filter body.

The present invention also relates generally to a method of treating a fluid to remove particles from the fluid, the method comprising the steps of:
a) diverting fluid into a filter via a manifold inlet of the filter, wherein the fluid comprises particles suspended therein;
b) flowing the fluid into a main filter body and over and through a tiered plate assembly from a top of the tiered plate assembly to a bottom of the tiered plate assembly and into a bottom portion of the filter;
c) disrupting particles held in suspension by the fluid to direct the particles towards an area of low flow at the bottom portion of the filter;
d) passing the fluid back up through the tiered plate assembly from the bottom of the tiered plate assembly to the top of the tiered plate assembly and out of the filter via a manifold outlet of the filter;
   wherein particles held in suspension by the fluid are removed and settle into a bottom of the main filter body.

### BRIEF DESCRIPTION OF THE FIGURES

For a fuller understanding of the invention, reference is made to the following description taken in connection with the accompanying figures, in which:

FIGS. 1A and 1B depicts view of two versions of a filter for use in a hydronic heating and/or cooling system in accordance with one embodiment of the present invention.

FIG. 2 depicts a cross-sectional view of the filter containing a flow interrupter in accordance with one embodiment of the present invention.

FIG. 3 depicts an exploded view of the flow interrupter in accordance with one embodiment of the present invention.

FIG. 4 depicts a view of multi-tiered flow interrupter for use in the filter in accordance with one embodiment of the present invention.

FIG. 5 depicts a view of the manifold with the feature of a bypass hole for use with the filter in accordance with one embodiment of the instant invention.

FIG. 6 depicts the direction of fluid flow through the filter and associated flow interrupter of the instant invention.

FIG. 7 provide the collection results of examples of several filters of the instant invention at various flow rates.

FIG. 8 depicts a comparison of the collection rate of the non-magnetic filter of the instant invention and a magnetic filter.

FIG. 9 depicts a comparison of the collection rate of various filters.

FIG. 10 depicts a comparison of the collection rate of the non-magnetic filter of the instant invention as compared with several prior art non-magnetic filters.

Also, while not all elements may be labeled in each figure, all elements with the same reference number indicate similar or identical parts.

### DETAILED DESCRIPTION OF THE PREFERRED EMBODIMENTS

The present invention relates generally to a filter comprising a flow disrupter that disrupts the flow of fluid through the filter by means of multiple collection and disruptive apertures and surfaces of varying size and position contained in a multi-tiered assembly. In doing so, the assembly removes particles and debris held in suspension by the fluid. The assembly encourages a change in the flow trajectories of these particles and debris, including, for example, magnetite and hematite particles, to settle into the body and base of the filter or to be captured on the surfaces of the flow disrupter at an acceptable collection capacity and rate.

The inventors of the present invention have found that the use of a system filter without the use of a magnet and only the flow disrupter described herein has yielded unexpected and positive results, especially in newer systems with relatively clean heating systems. Positive results are also seen in connection with heat pumps, which is a growing and expanding markets with higher flow rates and requiring lower pressure loss. Domestic dwellings typically have a flow rate of about 10 liters/minute, while heat pumps can have a flow rate of greater than about 30 liters/minute.

The flow disrupter of the invention has a significant impact on the overall performance of the filter. The flow disrupter works by disrupting the flow of fluid through the filter, and in doing so, removing particles held in suspension by the fluid. The flow disrupter also encourages a change in the flow trajectories of the particles, allowing the particles to settle into the body and base of the filter.

As noted above, many of the current filters used in hydronic heating and cooling systems use high power neodymium magnets, which typically contribute towards most of the total amount of system debris collected by a filter. However, during the development testing process of the instant invention, it was surprisingly discovered that the flow disrupter described herein was at least as effective at capturing dirt as a filter configuration containing a magnet. Moreover, during such testing, the filter proved to be increasingly effective as the flowrate increased.

Unlike many of the filtration methods employed by the prior art, the flow disrupter of the instant invention has a significant impact on the overall effectiveness of the filter for both magnetic and non-magnetic particles. Thus, the flow disrupter of the instant invention can decrease the velocity of both magnetic and non-magnetic particles, which encourages the settlement of both magnetic and non-magnetic particles and debris in the body of the filter.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath”, “below”, “lower”, “above”, “upper” and the like, are used for ease of description to describe one element or component's relationship to another element(s) or component(s) as illustrated in the figures. It is further understood that the terms “front” and “back” are not intended to be limiting and are intended to be interchangeable where appropriate.

As used herein, the terms “upstream” and “downstream” are used for ease of description to describe the relative position of elements and/or components within the system.

As used herein, the terms “comprises” and/or “comprising,” specify the presence of stated features, integers, steps, operations, elements, and/or components, but do not preclude the presence or addition of one or more other features, integers, steps, operations, elements, components, and/or groups thereof.

As used herein the term “substantially-free” or “essentially-free” if not otherwise defined herein for a particular element or compound means that a given element or compound is not detectable by ordinary analytical means that are well known to those skilled in the art of metal plating for bath analysis. Such methods typically include atomic absorption spectrometry, titration, UV-Vis analysis, secondary ion mass spectrometry, and other commonly available analytically methods.

The term “fluid” as used herein refers to water that is circulated through the system. It is contemplated that the water may include additives such as anti-freeze additives (i.e., ethylene glycol, etc.).

The terms “particles,” “particulate,” “dirt,” and “debris” are used interchangeably to refer to the material that is removed from the fluid in the hydronic heating and cooling system.

The flow coefficient (Kv) is defined as the flow rate in cubic meters per hour (m³/h) of water at a temperature of 16° C. with a pressure drop across the valve of 1 bar.

As described herein, the present invention relates generally to a filter for use in a hydronic heating and/or cooling system.

In one embodiment, the present invention relates generally to a filter for removing particles held in suspension by a fluid, the filter comprising:
a. a manifold having an inlet and an outlet;
b. a main filter body connected to the manifold, wherein the main filter body comprises a flow disrupter, the flow disrupter comprising a tiered plate assembly arranged in the filter body, wherein each plate in the tiered plate assembly comprises an arrangement of apertures,
   wherein fluid to be treated enters the filter through the inlet of the manifold, passes into the filter body and down through the apertures of tiered plate assembly and is redirected back up through the tiered plate assembly to exit through the outlet of the manifold, whereby particles held in suspension by the fluid are removed and settle into a bottom of the main filter body.

The filter of the present invention is preferably a modular composite design, which may be constructed from injection molded plastic or alternatively from a corrosion-resistant metal such as stainless steel or aluminum. The filter may be used for both a “low flow” domestic system and for a higher flow heat pump system. In a domestic system, typically flow rates are generally between about 5 and about 20 liters per minute, more preferably about 10 to about 15 liters per minute. In a heat pump system, typical flow rates can be up to six times higher than that of a domestic system.

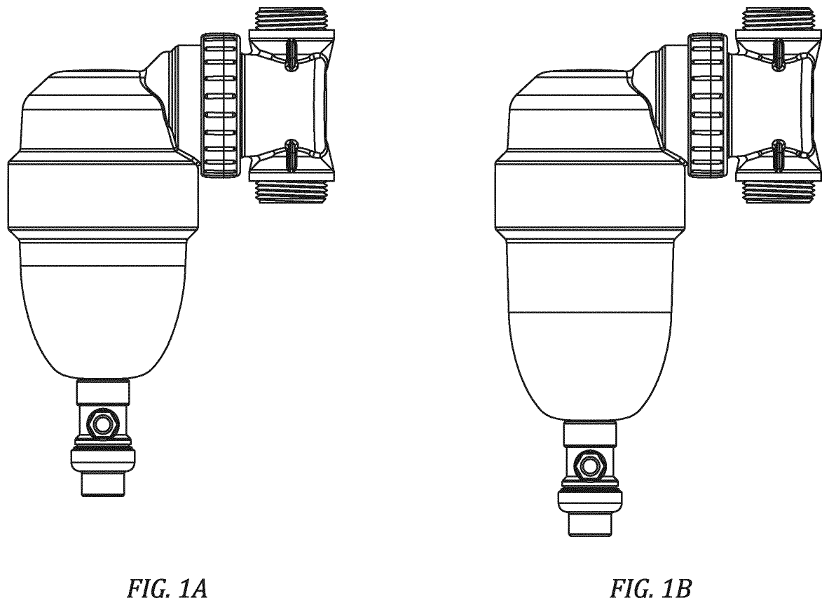

FIG. 1A depicts a view of a filter in accordance with the present invention for use in a domestic system, while FIG. 1B depicts a view of a filter in accordance with the present invention for use in a heat pump system. As seen from FIGS. 1A and 1B, the main difference between the two systems is the change in the main filter body in that the filter body of the filter usable in a heat pump system as depicted in FIG. 1B is elongated as compared with the filter body of the filter usable in a domestic system as shown in FIG. 1A. However, these arrangements are only examples and it is possible that a filter that exhibits a smaller/larger overall diameter and/or a shorter/longer length could also be used with the flow disrupter described herein. What is important to the function of the flow disrupter is the path of fluid through the flow disrupter that enables particles suspended in the fluid to be removed from the fluid and settle into the base of the filter body for subsequent removal.

The flow disrupter has a significant impact on the overall performance of the filter. The flow disrupter works by disrupting the flow of water through the filter, and in doing so, removes particles held in suspension by the water. The flow disrupter operates by encouraging a change in the flow trajectories of these particles, which allows particles to settle into the body and base of the filter.

Unlike many filtration technologies of the prior art, the flow disrupter of the filter of the present invention has a significant impact on the overall effectiveness of the filter. In other words, unlike the magnetic filters of the prior art, the flow disrupter of the present invention decrease the velocity of both magnetic and non-magnetic particles and debris suspended in the filter so that they may be removed from the fluid and settle into the base of the body of the filter.

By combining the unique design of the flow disrupter, within a body specifically designed to maximize capture rates all while ensuring reasonable flow path remains through the filter, the unique design of the invention offers a means of capturing a variety of particles and debris, including both magnetic and non-magnetic particles. The combination of these design features, including a calculated flow path design, ensures optimized collection without the possibility of blocking, make the technology and application unique and an integral part of the performance of the filter.

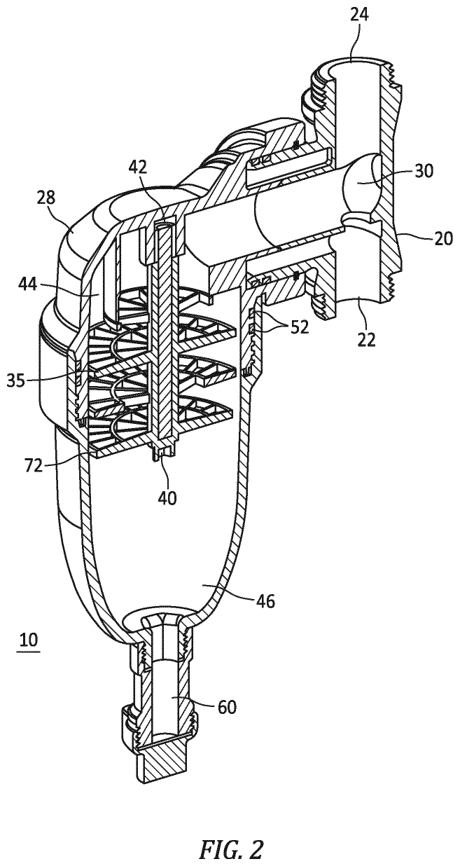

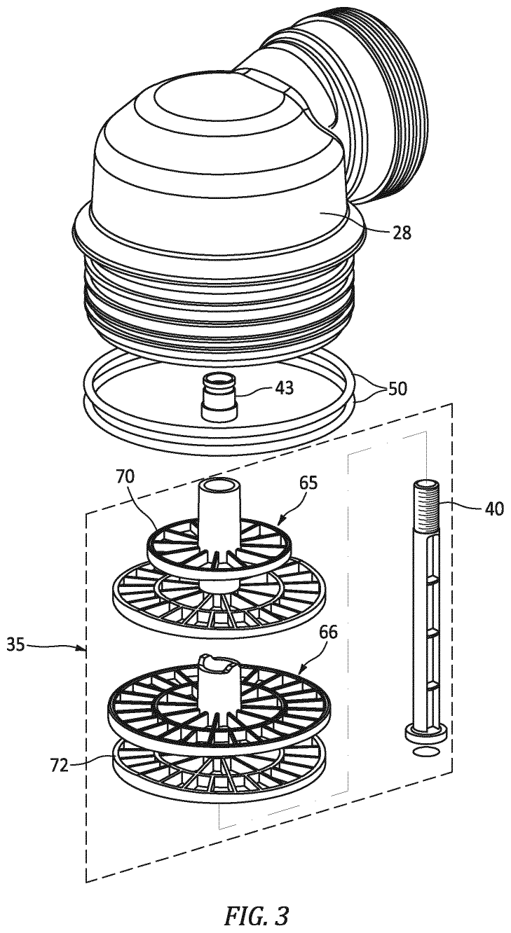

As shown in FIG. 2, in one embodiment, the filter 10 of the present invention includes a manifold 20 having an inlet 22 and an outlet 24 through which fluid enters and exits the filter 10. The manifold 20 is connected to a main filter body 28 that includes flow disrupter 35, comprising a tiered plate assembly that is held fixably in place by a bolt 40 that is secured into a recessed opening 42 at a top of main filter body 28. In one embodiment, the bolt 40 has a threaded end that is screwed into corresponding threads in recessed opening 42. In one embodiment, recessed opening 42 comprises an insert 43 (shown in FIG. 3) into which bolt 40 is threaded into. Optionally, but preferably, an adhesive may be applied to the threaded end and/or corresponding threads in the recessed opening to firmly secure the bolt 40 into place. The main filter body 28 comprises a top portion 44 and bottom portion 46. In one embodiment, the top portion 44 and 46 and molded as two separate pieces that are jointed together with an adhesive. Sealing rings 50 (shown in FIG. 3) may be positioned at location 52 between top portion 44 and bottom portion 46 to be sure that the portions are securely joined. Drain valve 60 is located at the bottom end of the bottom portion 46 of the main filter body 28.

In the embodiment shown in FIG. 2, the bolt 40 is threaded into the recessed opening. However, it is noted that other means could also be used to fixably attach the bolt to an interior top surface of the main filter body 28, including for example a screw fastener or mechanical clips. In addition, it is noted that bolt and/or fastening means can also be formed of various materials including, for example, injection molded plastic and corrosion-resistant metals such as stainless steel or aluminum. Furthermore, it is also contemplated that various configurations of the flow disrupter 35 could be formulated which do not use bolt 40. For example, the tiers of the tiered plate assembly may be fixably attached to interior side walls of the main filter body by mechanical clips or other means, or the bolt may secure the tiered plate assembly to a bottom of the interior surface of the main filter body 28. In any event, what is most important is that the flow disrupter is mounted within the main filter body 28 in such a way that the particles held in suspension by the fluid are able to separate from the fluid so that they may be removed and settle into the bottom of the main filter body 28.

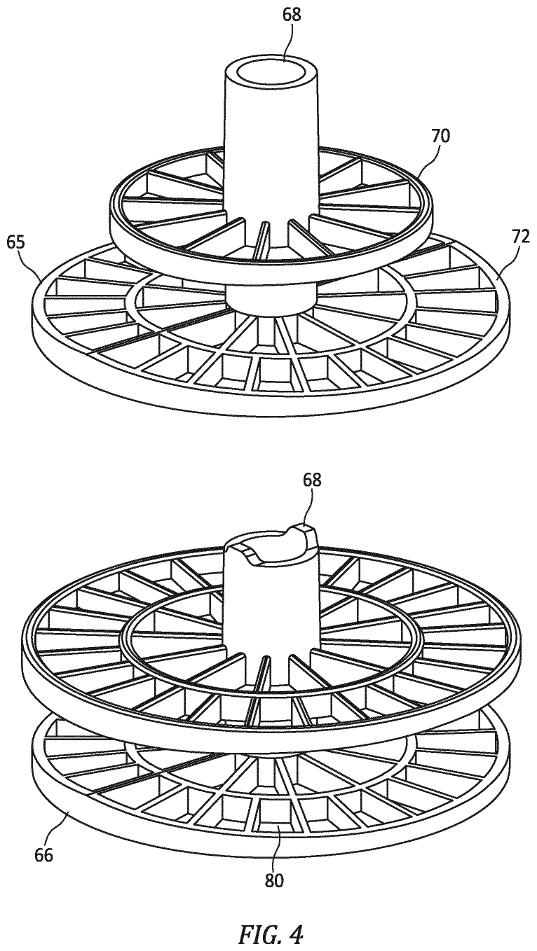

FIG. 3 illustrates the top portion 44 of the filter 10 and more clearly shows bolt 40 that supports the several plates 65 and 66 that comprise flow disrupter 35 in accordance with one embodiment of the present invention. FIG. 4 depicts another view of the several plates 65 and 65 that make up the flow disrupter 35.

As seen in FIGS. 3 and 4, in one embodiment, the flow disrupter 35 of the invention comprises a tiered plate assembly that includes a top tier 65 and a bottom tier 66 arranged around and joined to a cylindrical tube 68 through which bolt 40 is passed to mount the first tier 65 and the bottom tier 66 onto the bolt and secure the top tier 65 and bottom tier 66 into place within main filter body 28.

In one embodiment, the top tier 65 and bottom tier 66 are formed of injection molded plastic. Alternatively, the top tier 65 and bottom tier 66 may be formed by other means as would be known to those skilled in the art. In addition, while the top tier 65 and bottom tier 66 are preferably plastic to avoid corrosion, non-reactive metals such as stainless steel or aluminum, ceramics and other materials may also be used to form the flow disrupter 35 described herein.

Top tier 65 preferably comprises two plates, a smaller top plate 70 and a larger bottom plate 72. The smaller top plate 70 is designed to fit within the narrowing top portion 42 of main filter body 28. The larger bottom plate 72 is the same size as the plates that make up the bottom tier 66. The top tier 65 and bottom tier 66 are configured to be fixably held in position by the bolt 40. Thus, the plates 70 and 72 are designed not to move out of position so that alignment of the top tier 65 and bottom tier 66 of the flow disrupter 35 is maintained for best performance.

It is further noted that FIGS. 3 and 4 show an arrangement of two tiers, each tier comprising two plates. However, it is contemplated that the flow disrupter could also include additional tiers and additional plates within each tier depending on the needs of the particular system. Thus, the filter described herein is not limited to a particular number of plates and/or tiers that make up the flow disrupter 35. It is also noted that an additional number of plates 70 and 72 would also require a correspondingly extended bolt 40.

What is most important is that the configuration of the plates 70 and 72 that make up the flow disrupter 35 are arranged to maximize removal and collection of system debris and suspended particles. Therefore, the distance between the plates is set to facilitate best performance and one skilled the art could determine a suitable distance between the plates based on system needs.

The configuration of the apertures 80 is also important to the success of the invention. The size of the apertures 80 is based on typical debris and particles found within a heating system. If the apertures 80 are too small, they will block or restrict flow through the filter 10 if debris settles within the apertures 80. On the other hand, if the apertures 80 are too big, they will not effectively separate debris.

As seen in FIG. 4, top plate 70 comprises a plurality of apertures 80 in a wagon wheel configuration. That is, top plate 70 comprises an outer rim that comprises a plurality of spokes that are joined to cylindrical tube 68. The remaining plates 72 are similar to top plate 70 in that these plates 72 also have a wagon wheel configuration. However, due to their larger size, these plates 72 have a circular portion arranged equidistant from the cylindrical tube 68 and the outer edge and the apertures 80 along the outer edge are further bisected, such that the size of the apertures 80 in the inner circle of the wagon wheel and the outer circle of the wagon wheel are similar in size.

It is further contemplated that other arrangements of the apertures 80 in each of the plates 80 and 82 could also be determined to yield a similar result and the arrangement described herein is only one possible arrangement of apertures 80 to achieve the desired result.

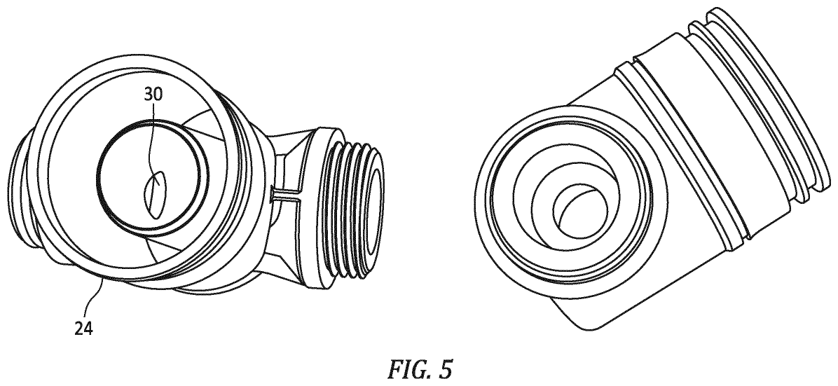

In one embodiment and as shown in FIG. 5, manifold 20 may comprise a bypass hole 30 within the manifold 20. This embodiment is generally used in the heat pump configuration shown in FIG. 1B. The inventors of the present invention have determined that the larger size of main body with its greater collection capacity at higher flow rates produces an optimal result. The bypass hole helps reduce flow through the main filter body, creating partial filtration, which is turn results in better settlement within the body of the filter 10. This is especially important when working at the higher flow rates realized by heat pump applications as it allows for improved capture rates and lower pressure loss. Moreover, the addition of the bypass hole 30 highlights the efficacy of the original design and validates its performance capabilities. Thus, the filter targeted for the heat pump market can be further optimized by use of a full bore valve which significantly reduces the fluid pressure loss within the filter when combined with the bypass 30 in the manifold 20.

These results are illustrated in Table 1.

TABLE 1
Comparison of Kv values

| Filter Configuration | KV Value |
|---|---|
| Valve | 5.9 |
| Valve (with 12 | 6.9 |
| mm bypass) | |
| Valve (full bore) | 7.8 |
| Valve (12 mm | 10.6 |
| bypass & full bore) | |

Kv values in Table 1 are based on the pressure differential at 50 L/minute, based on the following formula:

$$Kv = {Q}^{*} \sqrt{\frac{1 bar}{{Δ}_{p}} * \frac{ρ}{1000 \frac{kg}{{m}^{3}}}}$$

Where Q is the volume flow, Δp is the pressure drop, and ρ is the density of the liquid.

As seen in Table 1, the best performance is achieved with both bypass and a full bore valve.

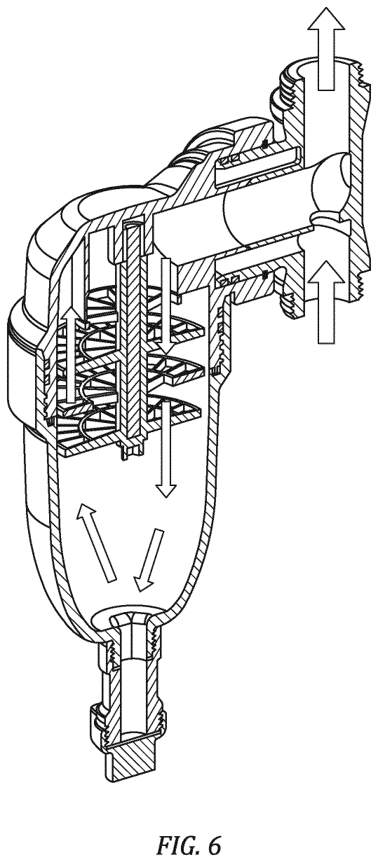

The calculated flow path of fluid through the filter 10 is shown in FIG. 6. As shown in FIG. 6, during operation, system fluid enters the filter via the manifold inlet and is directed onto and over the flow disrupter 35. As system debris and particles comes into contact with the tiered plate assembly that make up flow disrupter 35, contaminants, including magnetite, hematite, dirt and other particulate debris, are no longer held in suspension by the water and are able to settle into the bottom portion 46 of the filter 10. System fluid that passes down through the tiered plate assembly passes back through, around, and over the tiered plate assembly to exit from the outlet of the manifold. The flow of the fluid from the top of the tiered plate assembly to the bottom of the filter body and then back up to through the tiered plate assembly to the top portion of the filter body results in greater separation of system debris and particles from the fluid.

As the fluid flows over the flow disrupter, the fluid flow rate reduces, which allows heavy contaminants within the fluid to drop to the bottom of the filter body where it is collected. Clean water then exits the manifold via a smaller aperture, which increases the system fluid pressure back into the high flow required by the system.

Accumulated debris may be removed from the filter body periodically, such as during annual maintenance. In one preferred embodiment, the accumulated debris is removed by flushing or cleaning the system. In addition, each of the plates 70 and 72 of the tiered plate assembly can be cleaned using system back pressure. In this instance, the boiler is switched off and fluid is purged from the filter 10 through drain valve 60. All particles and debris separated by the tiered plate assembly settle in the bottom portion 46 of the main filter body 28 and can be easily removed by flushing the filter in this manner.

The inventors have found that the filter comprising the flow disrupter described herein offers comparable collection results to conventional magnetic filtration and exceeds the collection results of what is currently on the market in terms of non-magnetic filtration.

As illustrated in the Figures, the flow disrupter functions as follows:

1) fluid enters the filter 10 via the manifold inlet 22 carrying with it system debris and magnetite particles;

2) the fluid moves through the manifold 20 and enters the main filter body 28. The filter flows over the top plate 70 of the tiered plate assembly and then down through the remaining plates 72 and into the bottom portion 46 of the filter 10;

3) the water is forced down to the bottom of the filter 10 due to the design of the top portion 44 and flow disrupter 35. The flow disrupter helps to disrupt particles held in suspension by the water as well as to direct debris towards an area of low flow at the bottom of the filter 10.

4) apertures 80 within the plates 70 and 72 of the flow disrupter 35 enable the dynamic flow of fluid, down towards the bottom of the filter 10.

5) To exit the filter 10, water must pass back up through the flow disrupter 35 and out through the manifold outlet 24. In this way, system debris has difficulty escaping the unit, and is either trapped in the area of low flow or captured on the surfaces within the apertures 80.

In one embodiment, the system described herein can also be used in combination with a magnet to further improve the capture of magnetite within the system.

In another preferred embodiment, the invention described herein can be scaled up in a larger heating system to use larger components and used with multiple filter applications, from domestic markets up to and including commercial markets.

The collection capacity of the filter 10 is typically up to about 300 grams of debris and

particles based on the smaller unit depicted in FIG. 1A. The larger heat pump unit depicted in FIG. 1B is capable of capturing more debris and particles due to its comparatively larger size.

### Example 1

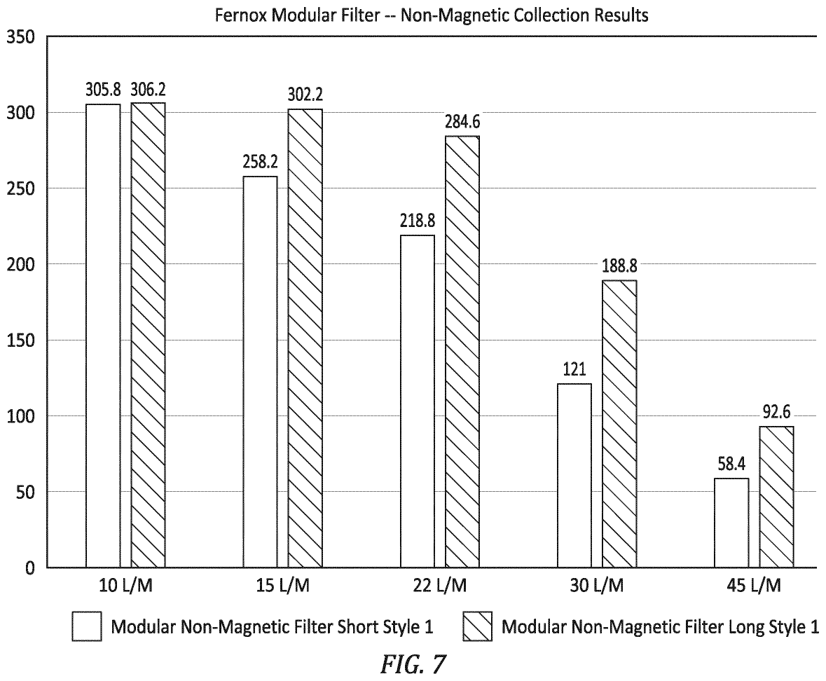

A collection test was performed using a standard collection capacity test to capture magnetite particles using the filter of the present invention at different flow rates ranging from 10 liters per minute to 45 liters per minute for both the smaller unit (i.e., Short Style 1) and larger heat pump unit (i.e., Long Style 1). The results are shown in FIG. 7. As shown in FIG. 7 at low flow rates, both systems were able to capture the same amount of particles. At higher flow rates, as would be expected, the larger unit was able to capture a greater capacity of particles.

### Example 2

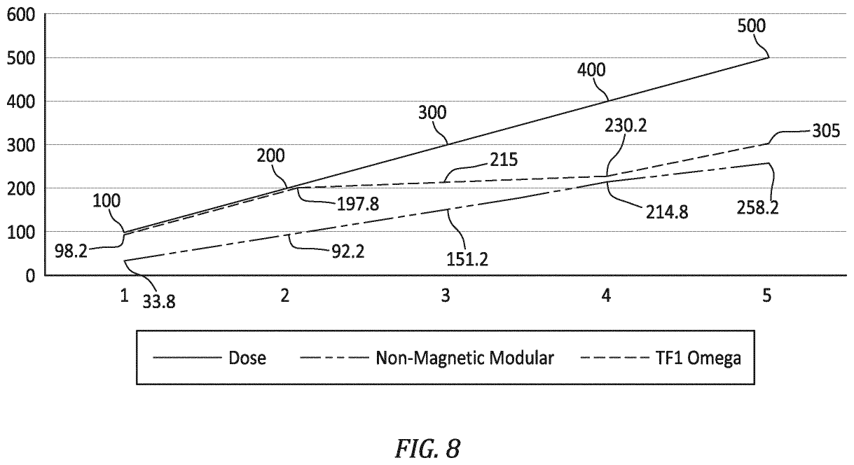

An incremental dose collection rate test was performed over time for the filter of the present invention as compared with a magnetic filter of the prior art. As shown in FIG. 8, the non-magnetic filter of the present invention was able to capture nearly the same amount of magnetic particles as the magnetic filter, without the use of an expensive magnet.

### Example 3

A collection test was performed using non-magnetic hematite particles in which a 100 gram

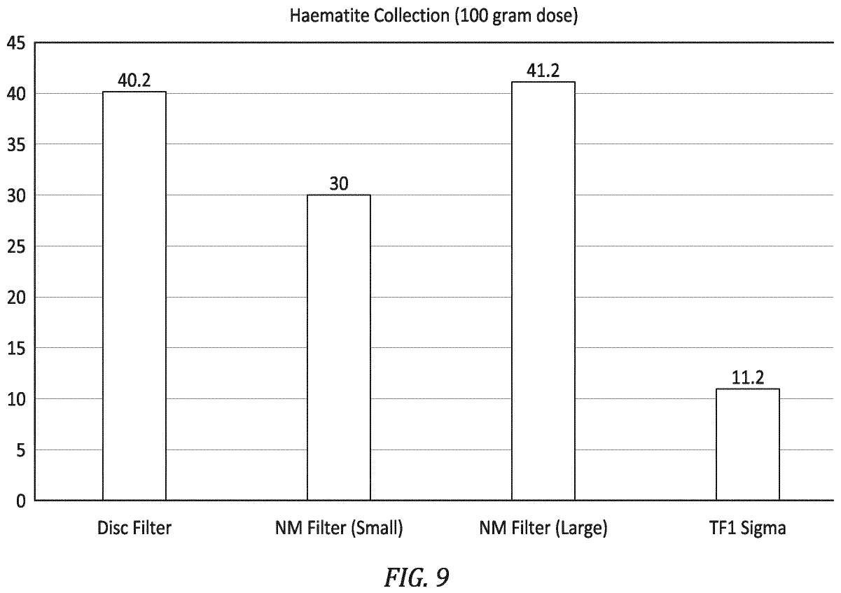

dose was circulated for one hour at 10 liters per minute. As shown in FIG. 9 the filters of the present invention were able to capture a much higher quantity of the non-magnetic particles than a magnetic filter system of a prior art.

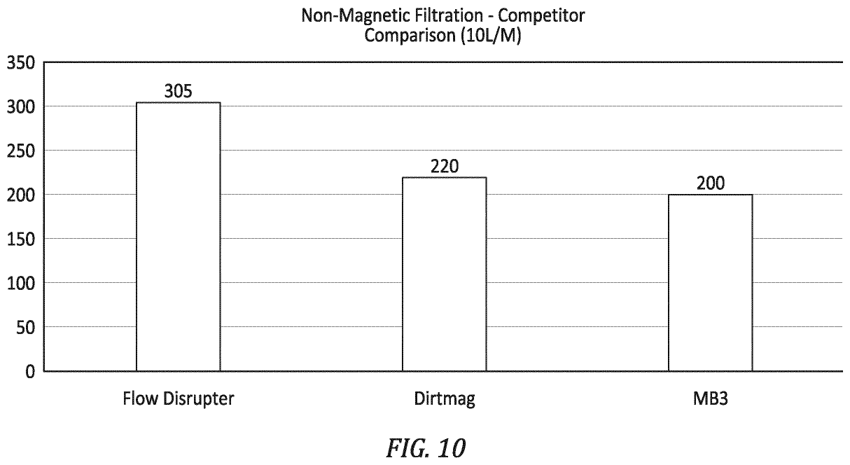

A second test was performed in which a 100 gram dose was circulated for one hour at 45 liters per minute and the results are shown in FIG. 10. As seen in FIG. 10, the best results were achieved when using a large bore valve and a bypass as described above.

Thus it can be seen that the invention described herein provides an improved filter for use in a hydronic heating and cooling system that does not require a magnet to achieve a desired result.

Finally, it should also be understood that the following claims are intended to cover all of the generic and specific features of the invention described herein and all statements of the scope of the invention that as a matter of language might fall there between.

1. A filter for removing magnetic and non-magnetic particles held in suspension by a fluid, the filter comprising:
a. a manifold having an inlet and an outlet;
b. a main filter body connected to the manifold, wherein the main filter body comprises a flow disrupter, the flow disrupter comprising a tiered plate assembly arranged in the filter body, wherein each plate in the tiered plate assembly comprises an arrangement of apertures,
wherein the inlet of the manifold, the tiered plate assembly, the outlet of the manifold and a bottom of the main filter body are configured to define a flow path for fluid to be treated, the flow path entering through the inlet of the manifold, passing into the filter body and down through the apertures of the tiered plate assembly, and passing the bottom of the main filter body which is configured to collect the magnetic and non-magnet particles removed from suspension in the. fluid to settle into the bottom of the main filter body, and the flow path being redirected hack up through the tiered plate assembly to exit through le outlet of the manifold; and
wherein the filter does not contain a magnet.

2. The filter according to claim 1, wherein the tiered plate assembly is fixably attached to a bolt, wherein the bolt is secured to a top inner surface of the main filter body.

3. The filter according to claim 2, wherein the bolt comprises a threaded end that is threaded into a corresponding recessed opening at the top inner surface of the main filter body.

4. The filter according to claim 2, wherein the tiered plated assembly comprises at least a top tier and a bottom tier arranged around and joined to a cylindrical tube, wherein the bolt is fitted through the cylindrical tube to attach the tiered plate assembly to the main filter body.

5. The filter according to claim 4, wherein the top tier comprises an upper plate and a lower plate, wherein the upper plate has a smaller diameter than the lower plate.

6. The filter according to claim 4, wherein the bottom tier comprises at least two plates.

7. The filter according to claim 5, wherein the upper plate of the top tier comprises an outer edge and a plurality of equidistant spokes that connect the out-r edge to the cylindrical tube, whereby a plurality of apertures are created.

8. The filter according to claim 5, wherein lower plate of the top tier comprises an outer edge and a second concentric circle arranged equidistant between the outer edge and the cylindrical tube, wherein a first set of spokes connect the outer edge to the second concentric circle to create a plurality of apertures and a second set of spokes connect the second concentric circle to the cylindrical tube, whereby a plurality of apertures are created.

9. The filter according to claim 6, wherein each of the plates of the lower tier comprises an outer edge and a second concentric circle arranged equidistant between the outer edge and the cylindrical tube, wherein a first set of spokes connect the outer edge to the second concentric circle to create a plurality of apertures and a second set of spokes connect the second concentric circle to the cylindrical tube, whereby a plurality of apertures are created.

10. The filter according to claim 1, wherein the manifold comprises a bypass hole, whereby flow through the main filter body is reduced.

11. The filter according to claim 10, wherein the manifold comprises a full bore valve to reduce fluid pressure loss within the filter.

12. The filter according to claim 1, wherein the main filter body comprises a top portion and a bottom portion and the flow disrupter is arranged in the top portion of the main filter body whereby, in use, when fluid to be treated enters the filter through the inlet of the manifold, the fluid passes into the top portion of the main filter body and down through the apertures of tiered plate assembly and into the bottom portion of the main filter body and is redirected back up through the tiered plate assembly in the top portion of the main filter body to exit through the outlet of the manifold, whereby particles held in suspension by the fluid are removed and settle into the bottom of the bottom portion of the main filter body.

13. A method of treating a fluid to remove magnetic and non-magnetic particles from the fluid using a filter, wherein the filter comprises:
a. a manifold having an inlet and an outlet;
b. a main filter body connected to the manifold, wherein the main filter body comprises a top portion and a bottom portion and a flow disrupter arranged in the top portion of the main filter body, the flow disrupter comprising a tiered plate assembly, herein each plate in the tiered plate assembly comprises an arrangement of apertures,
wherein the inlet of the manifold, the tiered plate assembly, the outlet of the manifold and the bottom portion of the main filter body are configured to define a flow path for fluid to be treated, the flow path entering through the inlet of the manifold, passing ow the ton portion of the main filter both and down through the apertures of the tiered plate assembly, and passing into the bottom portion of the main filter body which is configured to collect the magnetic and non-magnet particles removed from suspension in the fluid to settle into the bottom of the main filter body, and the flow path being redirected back up through the tiered plate assembly arranged in the top portion of the main filter body to exit through the outlet of the manifold, and wherein the filter does not contain a magnet; the method comprising the steps of:
a) diverting fluid into the filter via a manifold inlet of the filter, wherein the fluid comprises magnetic and non-magnetic particles suspended therein;)
b) flowing the fluid into the top portion of the main filter body and over and through tiered plate assembly from a top of the tiered plate assembly to a bottom of the tiered plate assembly and into the bottom portion of the main filter body;
c) disrupting particles held in suspension by the fluid to direct the particles towards an area of low flow at the bottom portion of the main filter body;
d) passing the fluid hack up through the tiered plate assembly from the bottom of the tiered plate assembly to the top of the tiered plate assembly and out of the filter via a manifold outlet of the filter;
wherein particles held in suspension by the fluid are removed and settle into the bottom of the bottom portion of the main filter body.

14. (canceled)

15. The method according to claim 13, wherein the bottom of the main filter body causes a change in the flow trajectories of the particles to settle into the bottom of the main filter body.

16. The method according to claim 13, wherein particles are also captured on surfaces of the tiered plate assembly.

17. The method according to claim 13 wherein the magnetic particles comprise magnetite particles and/or hematite particles.

18. The method according to claim 13, wherein the particles are filtered from a fluid in a hydronic heating or cooling system.

19. The method according to claim 18 wherein the particles comprise system debris in the hydronic heating or cooling system.

20. A hydronic heating or cooling system comprising the filter of claim 1.
